(19) United States
(12) Patent Application Publication
(10) Pub. No.: US 2018/0168266 A1
(43) Pub. Date: Jun. 21, 2018

(54) VISOR MIRROR SYSTEM AND METHOD

(71) Applicant: Jeffrey Mervin Windover, Bobcaygeon (CA)

(72) Inventor: Jeffrey Mervin Windover, Bobcaygeon (CA)

(21) Appl. No.: 15/385,488

(22) Filed: Dec. 20, 2016

(51) Int. Cl. A42B 3/04; G02B 5/08; G02B 7/182; A42B 3/22

(52) U.S. Cl. CPC A42B 3/0426; A42B 3/22; G02B 7/182; G02B 5/0808

(57) ABSTRACT

A safety device for use with a visor of a helmet is disclosed herein. The safety device for use with a visor of a helmet includes a body, a reflective surface, a stem, and a mounting bracket. The safety device for use with a visor of a helmet is useful for enabling a user-rider to see to the left-side, the right-side, and the rear-area of the user-rider with slight eye movement, and alternately with minimal head movement, while riding a vehicle, which may promote safer driving conditions.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of safety devices and more specifically relates to a visor mirror system.

### 2. Description of Related Art

Situational awareness is the perception of environmental elements and events with respect to time or space, the comprehension of their meaning, and the projection of their status after some variable has changed, such as time, or some other variable, such as an event. Lacking or inadequate situational awareness has been identified as one of the primary factors in accidents attributed to human error. Thus, situational awareness is especially important in domains where the information flow can be quite high and poor decisions may lead to serious consequences.

Situational awareness is further enabled by understanding the environment critical to decision-makers in both complex, dynamic areas from aviation, air traffic control, ship navigation, power plant operations, military command and control, and emergency services such as fire fighting and policing, as well as more ordinary but nevertheless complex tasks such as riding a motorcycle, a sport vehicle, or a bicycle.

In particular, when operating a motorcycle, a sport vehicle, or a bicycle, the driver/rider must constantly monitor the surrounding environment for approaching and encroaching traffic and other variables such as terrain and other obstacles. Failure to maintain good situational awareness can result in serious injury to the driver/rider and possibly others as well. A suitable solution is desired.

U.S. Pub. No. 2009/0128938 to Carnes relates to visors and rearview mirrors for helmets. The described visors and rearview mirrors for helmets include a visor that is especially useful for motorcycle riders and especially for off-road motorcycle racing. The visor has a sun shade member and a mirror. The mirror is affixed to an under surface of the sun shade member. The mirror has a continuous convex surface with a curvature that is free of discontinuations and step changes. The mirror is spaced an effective distance from the user's eyes and has a lateral span and a longitudinal span that are large enough so that the helmet wearer can simultaneously see approximately the same field of view to a side and rear with each eye by a slight turn and tilt of the user's head while an unobstructed line of sight in the direction of travel is retained. The invention also includes a mirror that can be retrofitted to various sun shade members and a kit for retrofitting the mirror in existing sun shade members.

### BRIEF SUMMARY OF THE INVENTION

In view of the foregoing disadvantages inherent in the known safety device art, the present disclosure provides a novel visor mirror system. The general purpose of the present disclosure, which will be described subsequently in greater detail, is to provide an attachable rear review mirror to a visor of a helmet to provide a motorcycle rider with greater situational awareness to further promote driver safety.

A safety device is disclosed herein. The safety device may include a body having an oblong shape, a reflective surface fixedly-attached to a front side of the body, a stem integrated with the body in perpendicular orientation to a top edge of the body, and a mounting bracket structured and arranged to couple the stem of the safety device to a mountable surface. The body, the reflective surface, the stem, and the mounting bracket are configured in structural and functional combination to attach the safety device to a visor of a head-protecting helmet.

The safety device may enable a user-rider of a motor vehicle to see to a left-side, a right-side, and a rear-area of the user-rider with slight eye movement or with minimal head movement while riding the vehicle to promote safer driving conditions. Preferably, the reflective surface is positioned at a 45-degree angle to the user's eyes to enable viewing with slight eye movement and alternately with minimal head movement.

A method of using the safety device is also disclosed herein. The method of using the safety device may comprise the steps of: placing a mounting bracket of a body to a mountable surface of a visor; installing at least one screw or at least one rivet to fixedly mount the safety device to the mountable surface of the visor; viewing the reflective surface to enable the user-rider to see to the left, right, and rear of the user-rider with minimal head or eye movement while operating the vehicle.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a visor mirror system, constructed and operative according to the teachings of the present disclosure.

FIG. 1 is a perspective view of the visor mirror system during an ‘in-use’ condition, according to an embodiment of the disclosure.

FIG. 2A is a front view of the visor mirror system of FIG. 1, according to an embodiment of the present disclosure.

FIG. 2B is a perspective view of the visor mirror system of FIG. 1, according to an embodiment of the present disclosure.

FIG. 3 is an exploded view of the visor mirror system of FIGS. 1-2B, according to an embodiment of the present disclosure.

FIG. 4 is a side view of the visor mirror system of FIGS. 1-3, according to an embodiment of the present disclosure.

FIG. 5 is a flow diagram illustrating a method of use the safety device, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a safety device and more particularly to a visor mirror system as used to promote safer driving conditions.

Generally, the visor mirror system includes a body, an arm, and a mounting plate as a single unit made of plastic. A convex mirror may be affixed to the body thereafter, completing mirror system.

When installed to a visor of a helmet, a rider may see if a vehicle is approaching the rider while looking in the mirror without turning his or her head. The rider may also turn his or her head to an angle of 45 degrees to either side of center to view a distance directly behind his or her head, which may allow for safer decision making and avoiding potential collisions with vehicles during a passing situation.

In such a manner, the rider only needs to turn his or her head and does not have to tilt his or her head up or down to view to the side and behind. This may be helpful in particular when riders are riding in groups and riders are keeping track of riders to either side and behind each other.

Use of the visor mirror is further advantageous when riding in sunny conditions when a rider having a mirror on only one side may be subject to inadvertent blinding by looking in to the sun or angled sun reflections in the mirror. With the visor mirror sytem, turning to the other side from the sun eleminates the issue of vision impairment from looking in to the sun.

The visor mirror system may further be constructed to withstand the forces of wind speed and wind pressure that may be experienced by a vehicle being driven at typical highway speeds. In some embodiments, the visor mirror system may be made of composite materials such as kevlar.

The visor mirror may be mounted to the visor of an existing helmet in an after-market installation. In light of this, the mounting plate may be flexible to fit with the contours of various styles and types of visors. The visor mirror may also be manufactured integrally with the visor of a riding helmet to eliminate the need for an after market installation. In addition, the visor mirror, when installed, does not interefere with the helmet eye shield, whether the eye shield is in the open, or the closed position.

The dimensions of the visor mirror are described by viewing the visor mirror from a side profile. The arm may be flat, similar to the back of the body and rounded on the other three sides. The arm may extend vertically at an angle of 90 degrees to the body. The arm may further have a length of 1¼ inches from the body to the mounting plate. In addition, the acrylic strip, which creates the reflective surface for the the visor mirror is ¾ inch by 3 ¼ inch by ⅛ inch. The body is ¾ inch by 3¼ inch with a maximum thickness of ¼ inch and is arched to form a 10 degree arch from each end to the center of the body. The arm is ½ inch long and ¼ inch in diameter, and the mounting plate is ¼ inch by 1 inch inch by ⅛ inch thick.

Further, the mounting plate may have an angle of 30 degrees angled toward the convex side of the body. The mounting plate may also be arched to aid in attachment to the underside of the visor with holes on each side of the plate to allow for hardware to fasten the visor mirror to a visor. The holes may correspond with mounting holes on the visor, the mounting holes being located at an equal distance from the center of the visor's peak. Alternatively, adhesive(s) may be used to install the visor mirror, which would elimintate both the requirement for making holes in the visor as well as the requirement for attaching hardware.

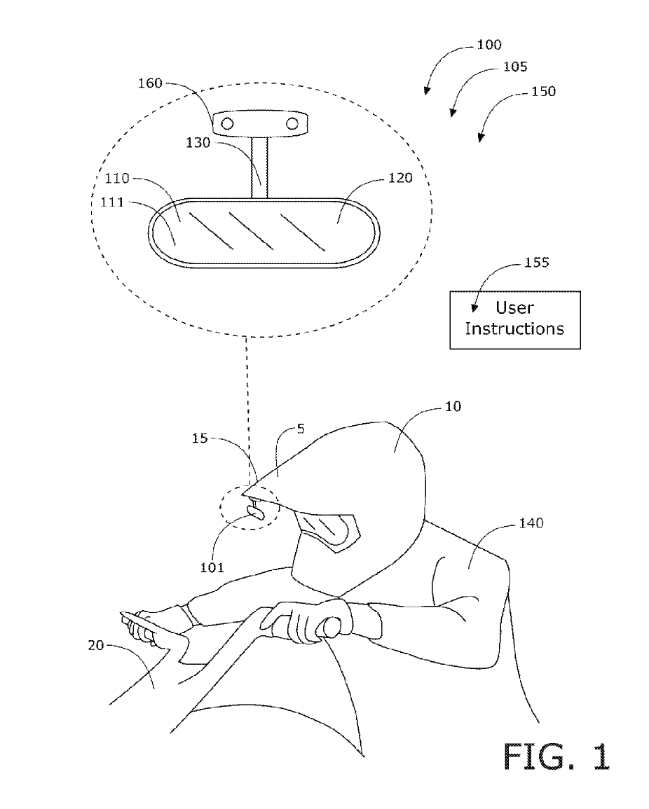

Referring now more specifically to the drawings by numerals of reference, there is shown in FIGS. 1-4, various views of a visor mirror system 100. FIG. 1 shows a visor mirror system 100 during an ‘in-use’ condition 150, according to an embodiment of the present disclosure. Here, the visor mirror system 100 may be beneficial for use by a user-rider 140 to attach the safety device 101 to a visor 5 of a head-protecting helmet 10. The visor 5 of the head-protecting helmet 10 may have a mountable surface 15 to which the safety device 101 may be fixedly-attached in a manner which may enable a user-rider 140 to see at a 45-degree angle to the left-side, a 45-degree angle to the right-side, and also to the rear-side of the user-rider 140 using slight eye or head movements.

The user-rider 140 may also employ minimal head movements to use the safety device 101 while riding a vehicle 20. Use of both slight eye movements and minimal head movements to gather information of the user-rider's 140 surroundings may promote safer driving conditions.

In particular, the head-protecting helmet 10 referenced here may be used in conjuction with operating a vehicle 20, where the vehicle 20 may include at least one of a motorized land vehicle, a motorized water vehicle, and alternately a bicycle.

As shown in FIG. 1, the visor mirror system 100 may include a body 110 having an oblong shape 111, a reflective surface 120 fixedly-attached to a front side of the body 110, a stem 130 integrated with the body in perpendicular orientation to the top edge of the body 110, and a mounting bracket 160.

According to one embodiment, the visor mirror system 100 may be arranged as a kit 105. In particular, the visor mirror system 100 may further include a set of instructions 155. The instructions 155 may detail functional relationships in relation to the structure of the visor mirror system 100 (such that the visor mirror system 100 can be used, maintained, or the like, in a preferred manner). Further, the instructions 155 may explain to how to mount the visor mirror system 100 to the head-protecting helmet 10.

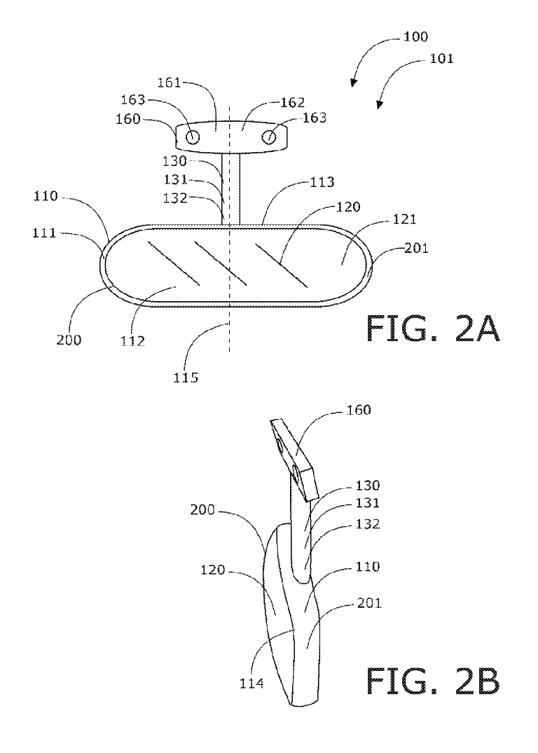

FIG. 2A shows a perspective view of the visor mirror system 100 of FIG. 1, according to an embodiment of the present disclosure. As above, the visor mirror system 100 may include a safety device 101 having a body 110, a reflective surface 120, a stem 130, and a mounting bracket 160. In referring to the body 110, the body 110 may have an oblong shape 111. The oblong shape 111 may further be configured to have a first-rounded end 200 and a second-rounded end 201. In continuing to refer to the body 110, the body 110 may include an arcuate profile 114 (as best shown in FIG. 2B). The arcuate profile 114 of the body 110 may be contoured to form an angle of approximately ten degrees from the center of the body 115 to the first-rounded end 200 and approximately ten degrees from the center of the body 115 to the second-rounded end 201.

In now referring to the reflective surface 120, the reflective surface 120 may be fixedly-attached to the front side of the body 110. The reflective surface 120 may be substantially made of acrylic-mirror materials 121. In other embodiments of the present invention, the reflective surface may be made of lightweight and shatterproof materials. The lightweight and shatterproof materials may include high optical grade reflective film, and alternately metallized film.

In continuing to refer to FIG. 2A, the safety device 101 may include a stem 130. The stem 130 may be integrated with the body 110 in a perpendicular orientation to the top edge of the body 113. Also, the stem 130 may be configured to have both a length 131 and a diameter 132 sufficient to support the body 110 with the reflective surface 120 and may be configured to be perpendicular to the mounting bracket 160.

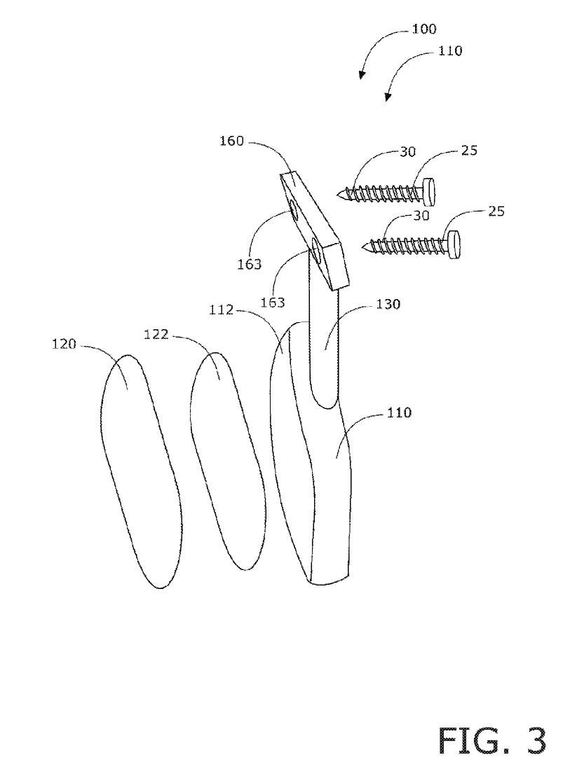

In now referring to the mounting bracket 160, the mounting bracket 160 may be structured and arranged to couple the stem 130 of the safety device 101 to the mountable surface 15 (as shown in FIG. 1) of the visor 5 of a head-protecting helmet 10. The mounting bracket 160 may comprise a plate 161 having a substantially square shape 162 and at least one through-hole 163. The through-hole(s) 163 may be configured to receive an attacher 25 (as shown best in FIG. 3), which may be useful for fixedly mounting the safety device 101 to the mountable surface 15 of the visor 5. Furthermore, the mounting bracket 160 may be configured to have dimensions of approximately ¼ inch in height, one inch in width, and 1/8 inch in thickness. In addition, the mounting bracket 160 may be configured to be deformable to accommodate a plurality of sizes and shapes that may be available for the mountable surface 15 of the visor 5.

FIG. 2B shows the visor mirror system 100 of FIG. 1, according to an embodiment of the present disclosure. As above, the visor mirror system 100 may include the body 110. The body 110 may be configured to have a height of approximately ¾ of an inch and a width of approximately ¾ inches. In other embodiments of the present invention, the body 110 may have a height with an approximate range between ¾ of an inch to 1½ inches and the width may have an approximate range of 2½ inches to 4½ inches.

In now referring to the stem 130, the stem 130 may be joined to the mounting bracket 160 at an approximate angle of thirty degrees such that the reflective surface 120 may be optimally positioned proximate to the user-rider's 140 visual field at an approximate 45-degree angle to the user-rider's 140 eyes. In particular, the stem 130 may be configured to have an approximate angle of thirty degrees from the vertical when viewed from the side. Also, the stem 130 may be configured to have a length 131 of approximately ½ inch and a diameter 132 of approximately ¼ inch. The stem may 130 be configured in an alternate embodiment of the present disclosure to have a square profile along the length 131, and alternately be configured to have a rounded profile along at least one edge of the length 131.

FIG. 3 is an exploded view of the safety device 101 of FIG. 1, according to an embodiment of the present disclosure. As shown here, the body 110, the reflective surface 120, the stem 130, and the mounting bracket 160 may be configured in structural and functional combination to provide a left-side, a right-side, and a rear view of the area proximate to a user-rider 140 (as shown in FIG. 1).

Preferably, the body 110, the stem 130, and the mounting bracket 160 may be substantially made of durable plastic materials having flexible and shatterproof properties. The materials having flexible and shatterproof properties may repeatedly withstand a plurality of velocities and a plurality of g-forces that the user-rider 140 may attain during use. In another embodiment of the present disclosure, the materials having flexible and shatterproof properties may include composite materials.

As above, the reflective surface 120 may be adhesively coupled to the front side of the body 112 via an adhesive 122. The adhesive 122 may be substantially made of durable materials. The durable materials may be resistant to dirt, moisture, and ultra-violet rays, to which the safety device 101 may be exposed to over time.

In now referring to the at least one through-hole 163, the at least one through-hole 163 of the mounting plate 160 may be useful for retaining attachers 25 for fixedly mounting the safety device 101 to the mountable surface 15 of the visor 5 via at least one screw 30 and alternatively at least one rivet should a more permanent installation be desired.

In another embodiment of the present disclosure, the attacher 25 may be configured to be a screw-with-nut assembly. Further, the at least one screw 30 and alternatively the at least one rivet may be configured to be a universal adapter structured to fixedly mount the safety device to the mountable surface of the visor. In this instance, the universal adapter may be made of wire, glue, and alternately a plastic cable tie.

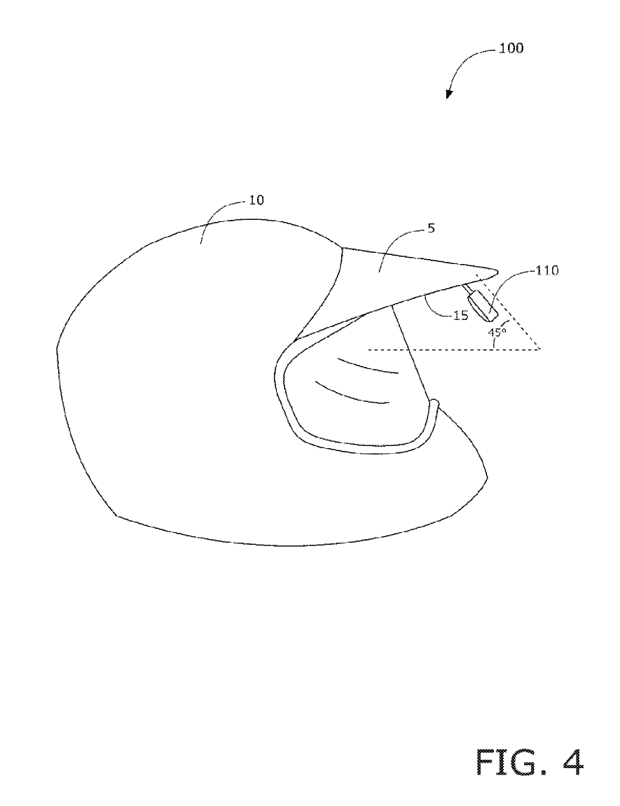

FIG. 4 is a side view of the safety device 101 of FIG. 1, according to an embodiment of the present disclosure. The the safety device 101 may be attached to a mountable surface 15 a visor 5 of a head-protecting helmet 10. In an installed condition, the safety device 110 may be positioned to be at an angle of 45-degrees to a user-rider's 140 eyes.

Upon reading this specification, it should be appreciated that, under appropriate circumstances, considering such issues as user preferences, design preference, structural requirements, marketing preferences, cost, available materials, technological advances, etc., other visor mirror system 100 arrangements such as additional configurations to attach the visor mirror system to visor-less safety helmets, and alternate shapes and attachment angles for the body, stem, and mounting bracket, etc., may be sufficient.

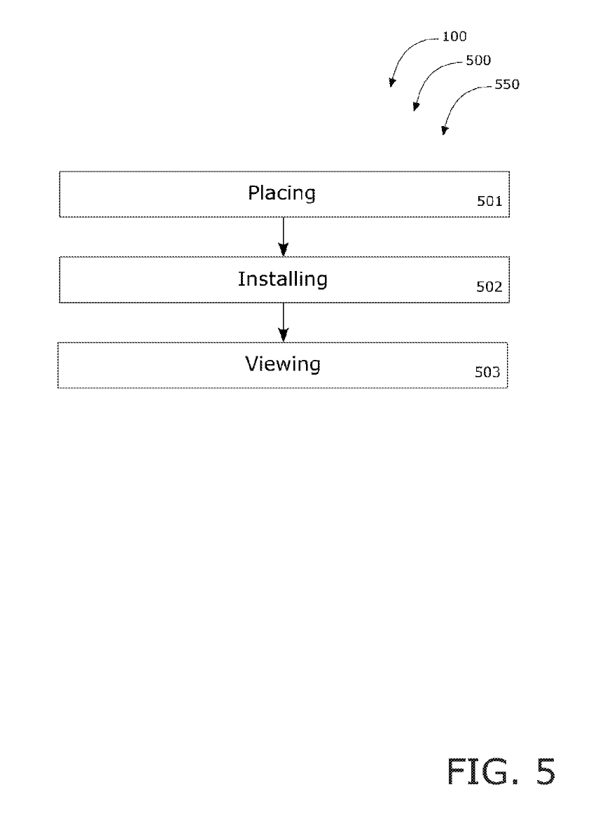

FIG. 5 is a flow diagram 550 illustrating a method of use 500 for the visor mirror system 100, according to an embodiment of the present disclosure. In particular, the method of use 500 for visor mirror system 100 may include one or more components or features of the safety device 101 as described above. As illustrated, the method for use 500 of safety device 101 may include the steps of: step one 501, placing a mounting bracket 160 of a body 110 adjacent to a mountable surface 15 of a visor 5; step two 502, installing at least one screw 30 and alternatively at least one rivet to fixedly mount a safety device 101 to the mountable surface 15 of the visor 5; and step three 503 viewing a reflective surface 120 to enable a user-rider 140 to see to a left-side, a right-side, and a rear-area of the user-rider 140 with slight eye movement, and alternately with minimal head movement, while riding a vehicle 20.

The use of “step of” should not be interpreted as “step for”, in the claims herein and is not intended to invoke the provisions of 35 U.S.C. § 112(f). It should also be noted that, under appropriate circumstances, considering such issues as design preference, user preferences, marketing preferences, cost, structural requirements, available materials, technological advances, etc., other methods for visor mirror system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A safety device comprising:
a body having an oblong shape;
a reflective surface fixedly-attached to a front side of the body;
a stem integrated with the body in perpendicular orientation to a top edge of the body, the stem having a length and a diameter; and
a mounting bracket structured and arranged to couple the stem of the safety device to a mountable surface;
wherein the body, the reflective surface, the stem, and the mounting bracket are configured in functional combination to attach the safety device to a visor of a head-protecting helmet having the mountable surface to enable a user-rider to see to a left-side, a right-side, and a rear-area of the user-rider with slight eye movement and alternately with minimal head movement while riding a vehicle to promote safer driving conditions.

2. The safety device of claim 1, wherein the body is structured with an arcuate profile to increase a range of vision of the user-rider.

3. The safety device of claim 2, wherein the stem is joined to the mounting bracket at an approximate angle of thirty degrees such that the reflective surface is optimally positioned at a 45 degree angle to the eyes of the user-rider.

4. The safety device of claim 3, wherein the body, the stem, and the mounting bracket are substantially made of durable plastic materials having flexible and shatterproof properties to repeatedly withstand a plurality of velocities and a plurality of g-forces.

5. The safety device of claim 4, wherein the reflective surface is substantially made of acrylic-mirror materials.

6. The safety device of claim 4, wherein the body having the oblong shape is configured to have a first-rounded end and a second-rounded end.

7. The safety device of claim 6, wherein the arcuate profile of the body having the oblong shape is contoured at an angle of approximately ten degrees from a center of the body between the first-rounded end and the second-rounded end.

8. The safety device of claim 6, wherein the wherein the body is configured to have a height of approximately ¾ of an inch and a width of approximately 3¼ inches.

9. The safety device of claim 5, wherein the reflective surface is adhesively coupled to the front side of the body via an adhesive.

10. The safety device of claim 1, wherein the mounting bracket comprises a plate having at least one through-hole.

11. The safety device of claim 10, wherein the at least one through-hole of the plate is useful for fixedly mounting the safety device to the mountable surface of the visor via at least one screw and alternatively at least one rivet.

12. The safety device of claim 10, wherein the at least one screw and alternatively the at least one rivet is configured to be a universal adapter structured to fixedly mount the safety device to the mountable surface of the visor.

13. The safety device of claim 10, wherein the at least one through-hole is configured to receive an attacher useful for fixedly mounting the safety device to the mountable surface of the visor.

14. The safety device of claim 10, wherein the mounting bracket is configured to be deformable to accommodate a plurality of sizes and shapes of the mountable surface of the visor.

15. The safety device of claim 1 wherein the vehicle comprises a motorized land vehicle.

16. The safety device of claim 1 wherein the vehicle comprises a motorized water vehicle.

17. The safety device of claim 1 wherein the vehicle comprises a bicycle.

18. A safety device for use with a visor of a helmet, the safety device comprising:
a body having an oblong shape;
a reflective surface fixedly-attached to a front side of the body;
a stem integrated with the body in perpendicular orientation to a top edge of the body, the stem having a length and a diameter; and
a mounting bracket structured and arranged to couple the stem of the safety device to a mountable surface;
wherein said body comprises an arcuate profile to increase a range of vision of the user-rider;
wherein the stem is joined to the mounting bracket at an approximate angle of thirty degrees such that the reflective surface is optimally positioned at a 45 degree angle to the eyes of the user-rider;
wherein the body, the stem, and the mounting bracket are substantially made of durable plastic materials having flexible and shatterproof properties to repeatedly withstand a plurality of velocities and a plurality of g-forces;
wherein the reflective surface is substantially made of acrylic-mirror materials;
wherein the body having the oblong shape is configured to have a first-rounded end and the second-rounded end;
wherein the arcuate profile of the body having the oblong shape is contoured at an angle of approximately ten degrees from a center of the body between the first-rounded end and a second-rounded end;
wherein the wherein the body is configured to have a height of approximately ¾ of an inch and a width of approximately 3¼ inches;
wherein the reflective surface is adhesively coupled to the front side of the body via an adhesive;
wherein the mounting bracket comprises a plate having at least one through-hole;
wherein the at least one through-hole of the plate is useful for fixedly mounting the safety device to the mountable surface of the visor via at least one screw and alternatively at least one rivet;
wherein the at least one through-hole is configured to receive an attacher useful for fixedly mounting the safety device to the mountable surface of the visor;
wherein the mounting bracket is configured to be deformable to accommodate a plurality of sizes and shapes of the mountable surface of the visor;
wherein the vehicle comprises a motorized land vehicle;
wherein the vehicle comprises a motorized water vehicle;
wherein the vehicle comprises a bicycle; and
wherein the body, the reflective surface, the stem, and the mounting bracket are configured in functional combination to attach the safety device to a visor of a head-protecting helmet having the mountable surface to enable a user-rider to see to a left-side, a right-side, and a rear-area of the user-rider with slight eye movement and alternately with minimal head movement while riding a vehicle to promote safer driving conditions.

19. The safety device of claim 18 further comprising a kit, the kit including:
the body having the oblong shape and having the reflective surface fixedly-attached to the front side of the body;
the stem integrated with the body;
the mounting bracket; and
a set of user installation instructions.

20. A method of using a safety device, the method comprising the steps of:
placing a mounting bracket of a body adjacent to a mountable surface of a visor;
installing at least one screw and alternatively at least one rivet to fixedly mount a safety device to the mountable surface of the visor; and
viewing a reflective surface to enable a user-rider to see to a left-side, a right-side, and a rear-area of the user-rider with slight eye movement, and alternately with minimal head movement while riding a vehicle.
